(19) United States
(12) Patent Application Publication
(10) Pub. No.: US 2024/0177011 A1
(43) Pub. Date: May 30, 2024

(54) NEURAL NETWORK WORD CLUSTERING SYSTEM

(71) Applicant: SAP SE, Walldorf (DE)

(72) Inventors: MAREK POLEWCZYK, Berlin (DE); Marco SPINACI, Versailles (FR); Xiang YU, Berlin (DE)

(21) Appl. No.: 18/071,231

(22) Filed: Nov. 29, 2022

(51) Int. Cl. G06N 3/09

(52) U.S. Cl. CPC G06N 3/09

(57) ABSTRACT

Various embodiments for a neural network clustering system are described herein. An embodiment operates by detecting a plurality of bounding boxes and identifying coordinates for each of the bounding boxes. An adjacency matrix is generated based on combining a key matrix and a query matrix. The plurality of words are clustered into a plurality of clusters, each cluster corresponding to a different line on the first document. A second document is generated in which the plurality of words corresponding to a respective cluster of the plurality of clusters is arranged on a same line on the second document. The second document is provided for display.

### BACKGROUND

In the field of computing, neural networks are often to classify inputs into a set of known classes based on shared attributes of the inputs. The classes of inputs become known to the neural network through an extensive training process. However, using a set of rigid classes to analyze input can limit the utility of the neural network. For example, classification often requires that the class definitions need to be defined beforehand which may require extra training and limit the types of inputs that neural network is capable of handling.

### BRIEF DESCRIPTION OF THE FIGURES

The accompanying drawings are incorporated herein and form a part of the specification.

FIG. 1 illustrates a block diagram illustrating a neural clustering system (NCS), according to some example embodiments.

FIG. 2 illustrates an example adjacency matrix, according to some embodiments.

FIG. 3 illustrates example line clusters as may be generated by NCS, according to some example embodiments.

FIG. 4 is a flowchart illustrating a process for a neural clustering system (NCS), according to some embodiments.

FIG. 5 is a flowchart illustrating another process for a neural clustering system (NCS), according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

In the field of computing, neural networks are often to classify inputs into a set of known classes based on shared attributes of the inputs. The classes of inputs become known to the neural network through an extensive training process. However, using a set of rigid classes to analyze input can limit the utility of the neural network. For example, classification often requires that the class definitions need to be defined beforehand which may require extra training and limit the types of inputs that neural network is capable of handling.

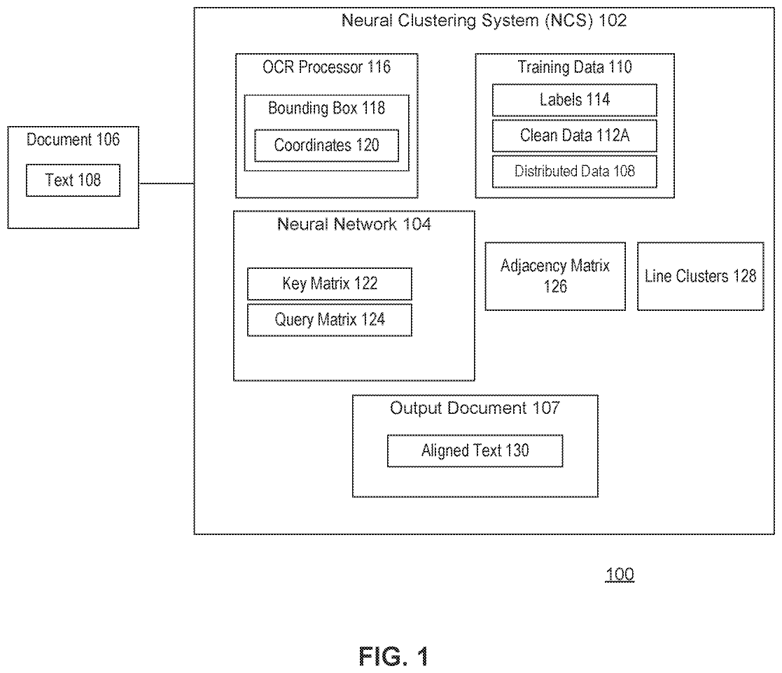

FIG. 1 illustrates a block diagram 100 illustrating a neural clustering system (NCS) 102, according to some example embodiments. Rather than performing classification and grouping various inputs into pre-defined classes as may be performed by conventional neural networks, NCS 102 performs clustering utilizing a neural network 104 trained to performed clustering.

There are some significant differences between classification as generally performed, and clustering as it is performed by NCS 102. For example, if there are a set of items to be grouped, classification requires assigning a specific and class from a set of predefined classes, to each item and then sorting the items into the corresponding class. Each class, in classification, has predefined attributes that differentiate it from other classes. The neural network that is performing classification has to be specifically trained to identify the various classes, their attributes, and variations, which is a time consuming and resource intensive process which requires extensive knowledge of the data that is to be input and the actual desired classes for which the classification is to be performed beforehand. Classification requires both predefining the set of classes with corresponding attributes, and ensuring each input data item to be classified belongs to one of the classes (and not multiple classes), otherwise the system could produce errors if it receives an unclassifiable object or input.

By contrast, clustering with neural network 104 (which may include either general clustering or supervised clustering), as performed by NCS 102 is different from general classification. General clustering allows for any items to be received as input, without any previous knowledge of the attributes or characteristics of the items beforehand (e.g., no predefined classes with known characteristics are required). Neural network 104 may then group or cluster the items based on characteristics discovered during the processing. Each group or cluster may include items that are the most similar to each other, without adhering to a strict class structure. Every item can be clustered into a group, while in classification, some items may not belong to any predefined class. Further, in classification, the items may be shifted between groups as new items are processed and the similarity or makeup of those groups or clusters change or adapts.

In addition to performing general clustering, NCS 102 may also or alternatively perform supervised clustering. In supervised clustering, a particular characteristic of an input item may be provided as the basis or initial basis upon which to cluster or group different items that are being processed, and this characteristic(s) may be used as or correspond to the label for the different groups or clusters. For example, in supervised clustering, if the inputs correspond to different vehicles to be clustered, the inputs may be clustered based on the number of wheels that each vehicle has, or their weight. Neural network 104 may then generate different clusters or groups based on the initial identified attribute(s). In some embodiments, supervised clustering may include providing names for the clusters corresponding to the primary or initial attribute, such as 0 wheels, 1 wheeled, 2 wheeled, 3 wheeled, etc.

Because of the different parameters and objectives, the ways in which clustering and classification are performed computationally, from a machine learning or neural network aspect, are vastly different from each other.

In the example of FIG. 1, NCS 102 may train and/or direct neural network 104 to perform supervised clustering to identify or separate the text 108 of a document 106 into different lines. For example, document 106 may be an image of a document which may include some distortion or skewing that makes the text 108 difficult to read for a person or computing system. NCS 102 may identify which text 108 is supposed to appear on which rows using supervised clustering, realign the text 108 by removing or reducing the effect of the distortion or skewing, and produce a more clearly aligned output document 107. Text 108 may include any alphanumeric text and/or images that are included in document 106, arranged or aligned across one or lines in document 106.

In some embodiments, NCS 102 may cluster the text 108 into different line groups or line clusters 128 based on their position (e.g. horizontal and/or vertical) on the document 106 relative to other words or text 108 on the document 106. As used herein, the terms clustering and supervised clustering may be used interchangeably, while general clustering may be referred to as separate process. In some embodiments, as a result of the clustering, NCS 102 may generate and provide for display on a user interface, or to another system, output document 107 which may include the original text 108 arranged with more precise alignment in accordance with the line clusters 128.

Unlike in general classification, the various clusters into which input items may be grouped or arranged by NCS 102 do not correspond to a specific label with a known or predefined set of attributes. As noted above, grouping, in the clustering context of NCS 102, may be done according to items of the population having similar features, but these features do not necessarily need to have been fully defined during the training of neural network 104.

In some embodiments, in the supervised clustering of NCS 102, labels 114 may be provided as part of training data 110. In some embodiments, the labels 114 may indicate or correspond to a single characteristic that is used to group or cluster the data, and which may have been used in training the neural network 104 with training data 110.

The training data 110 may include the set of data that is used to train neural network 104 for clustering the population of inputs (e.g., identifying which words are aligned on which lines of documents 106). In some embodiments, the training data 110 may include clean data 112A, distorted data 112B, and labels 114.

Clean data 112A may include various documents in which text is clearly aligned across different lines of the document. The lines of the document may be invisible but can include a horizontal and/or vertical alignment of the text. Aligned text may include when two lines of text are parallel or close to parallel to each other (e.g., within a minimum threshold of distortion), and may include horizontal and/or vertical alignment. Distorted data 112B may include a document in which one or more letters, numbers, words, or symbols include some level of distortion such that the parallel or perpendicular nature of the textual alignment is distorted, and the alignment of the text is no longer parallel (e.g., beyond a threshold). Neural network 104 may be trained to perform clustering based on the horizontal and/or vertical positions of various words, letters, or other text of a document.

As noted above, in supervised clustering, neural network 104 may be provided or trained with a set of labels 114. The labels 114 may help generally distinguish between different groups or clusters. In some embodiments, the labels 114 may correspond to the primary feature(s) used to cluster the items into different groups. For example, in continuing the document alignment example, the labels may be simply be line 1, line 2, line 3, etc.

As noted above, NCS 102 may receive a document 106 with some text 108. The document 106 may include any type of document, including but not limited to a word processing document, a spreadsheet, a webpage, a slide, and can span one or more pages. In some embodiments, document 106 may include an image of a document such as an image of a sign, a receipt, an invoice, or other print out or other real world object. The document 106 may include text 108 which may include any alphanumeric text, symbols, images, in any language(s). In some embodiments, the text 108 may be organized across various vertical or horizontal lines.

In some embodiments, document 106 may include a skewing or distortion such that the words and letters arranged across different lines do not appear to be horizontally or vertically parallel or perpendicular. In some embodiments, NCS 102 may receive document 106 and generate output document 107 with adjusted or better aligned text 108 for reading by a human or another computing system.

In some embodiments, NCS 102 may include or be connected to an optical character recognition (OCR) processor 116 (also referred to herein as OCR 116). OCR 116 may include a processor that is configured to identify words, numbers, and symbols of text 108 across one or more languages from text 108 of document 106. In some embodiments, OCR 116 may receive an image of document 106 as input and provide a version of the document 106 with a bounding box 118 as output. Bounding box 118 may include one or more bounding boxes for each of the identified letters, words, numbers, punctuation, and symbols identified from the text 108 of document 106 (the terms bounding box 118 and bounding boxes 118 may be used interchangeably).

In some embodiments, the bounding box 118 may include a set of coordinates 120 indicating a relative position and size (and in some embodiments, shape) of each bounding box. For example, document 106 may divided into an <X, Y> coordinate system, and each bounding box 118 may include a starting position or coordinates 120 of a top left corner of the bounding box 118, and a size (length and width) of the rectangular bounding box 118.

In some embodiments, OCR 116 may be a separate system that generates and provides the bounding boxes 118 of document 106 to NCS 102 or neural network 104. Then, for example, neural network 104, which may have been trained to identify which words appear on which lines using the supervised clustering system described herein, may cluster the words into line clusters 182 based on the various identified bounding boxes 118.

In some embodiments, neural network 104 may include a transformer. The transformer may be a portion of neural network 104 designed to solve sequence-to-sequence tasks while handling long-range dependencies. In some embodiments, NCS 102 may include a modification of the attention mechanism of transformers of neural network 104. In some embodiments, transformer models may rely mainly on the self-attention mechanism which may be used to find or identify dependencies between inputs. The self-attention mechanism may allow the inputs to interact with each other and find out to what they should pay more attention. In some embodiments, neural network 104 may derive three vectors query, key, and value for the input sequence and use these vectors for calculating attention:

$$Attention ( Q , K , V ) = softmax ( \frac{Q {K}^{T}}{\sqrt{{d}_{k}}} ) V$$

In some embodiments, attention scoring function may be calculated using the dot-product similarity. This may be a mechanism relating different positions of a single sequence in order to compute a representation of the sequence.

$$dot\_scores = \frac{{QK}^{T}}{\sqrt{{d}_{k}}}$$

In some embodiments, a transformer encoder may take as input, an embedded input sequence of shape <batch size, input sequence size, embedding size> and may output a matrix of the same shape. In order to classify each input from the input sequence, neural network 104 may include an output fully connected layer to map the transformer output to <batch size, input sequence size, number of classes> (which may include a batch of matrices of shape <input sequence size, number of classes>) and perform classification using cross-entropy loss function.

In order to perform clustering, NCS 102 may include neural network 104 with a transformer that is trained (with training data 110) with a modified last layer above. In some embodiments, the output batch of matrices above may be split into two batches of matrices, including a query matrix 124 and a key matrix 122, each of shape <batch size, input sequence size, embedding size/2>. In some embodiments, these two matrices can be of different sizes or shapes, and both do not need to have the same shape <batch size, input sequence size, embedding size/2>. For example, in some embodiments, the last dimension can be any arbitrary value (so long as the two Q and K matrices have the same value), similar to how the output layer can have an arbitrary number of classes (as described above). Neural network 104 may then mimic attention scoring with them: QK^{T}, which outputs a batch of matrices of shape <batch size, input sequence size, input sequence size>.

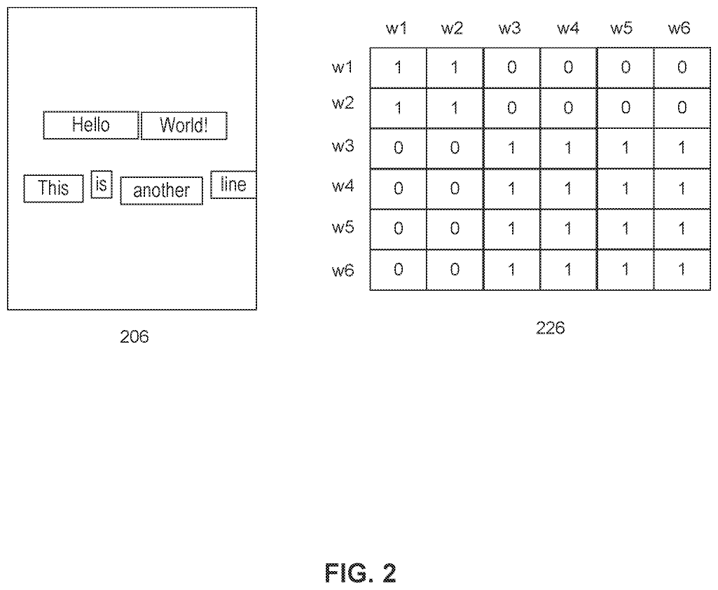

In this way, neural network 104 may generate an adjacency matrix 126 that represents which inputs in the sequence are similar to each other. In some embodiments, the adjacency matrix 126 may include values from 0 to 1 in the array and a sigmoid function and binary cross-entropy may be used to train the model. In some embodiments, the predicted adjacency matrix may include values in the range <0, 1> because a sigmoid function is applied to the result, i.e. the adjacency matrix may be (sigma) σ(QK^{T}) and not simply QK^{T}—which, itself, may take arbitrary real values. The adjacency matrix 126 may represent which inputs in the sequence should be grouped together (e.g., belong to the same cluster). The loss may be computed elementwise on the two square matrices (the predicted σ(QK^{T}) and the adjacency matrix 126), and then aggregated (e.g. via sum). In some embodiments, the adjacency matrix 126 may include a ground truth adjacency matrix which has values that are either 0 (not clustered together) or 1 (to be clustered together), as illustrated in FIG. 2.

During inference, neural network 104 may pass the output through the sigmoid function and since the output should be symmetrical (if element A should be clustered with element B, then element B should be clustered with element A), neural network 104 may add the output matrix with its transpose and consider entries which are above 1 as true connections (i.e. σ(QK^{T})+σ(KQ^{T})≥1). Moreover, the model may make mistakes and miss some Is in the output, so in some embodiments, a connected components algorithm may also be executed on the result: for example if the model predicted that A should be clustered with B and B should be clustered with C, but the information that A should be clustered with C is not predicted correctly.

The step described above of running connected components on the output of the predicted σ(QK^{T}) serves in shaping the output of adjacency matrix 126. However, it can introduce some errors of its own: if two clusters are correctly predicted, a single wrong prediction of a “1” between any word of these two clusters would lead to wrongly merging them into a single cluster.

In some embodiments, this process of only grouping together may be performed if one cluster does not belong to the vertical extension of the other, and addresses issues commonly found in word clustering. In some embodiment, for general clustering other conditions might be used: for example, one could prevent merging two clusters together if doing so would result in grouping together two words that have strongly voted against it. For example, if two words are being considered to join together because their score of σ(QK^{T})+σ(KQ^{T}) is equal to 1.4 (as an example value), but two other words in the two clusters to be joined have a score of σ(QK^{T})+σ(KQ^{T})=0.2, then they are voting “90% against” while the other two words are voting “70% for”, so the merging could be prevented. This may help avoid clustering too many or incorrect words together.

For this reason, neural network 104 may use the matrix of predicted scores σ(QK^{T})+σ(KQ^{T}) to decide which words to cluster together (starting from the pairs having the highest scores), but only proceed in merging if doing so does not result in two words of the same cluster such that one belongs to the vertical extension of the other.

For example, neural network 104 may consider both horizontal words extensions and vertical words extensions, or just vertical word extensions as described herein (e.g., without considering horizontal word extensions, which would save time and processing resources). Neural network 104 may group words (and the clusters they have already formed) together if they belong in each other's horizontal word extensions, but only if doing so would not make any of the words in the first cluster intersect with the vertical extension of any of the words in the other cluster.

In some embodiments, training the neural network 104 may include inputting, for example, shape <1000, 8> where 1000 is the number of supported words and 8 are 4 points with x, y coordinates. In this example, for each document we use max 1000 words and we use padding if there are fewer than 1000 words. The points values are scaled to be in range <0, 1000> and rounded to integers. In some embodiments, padding may be optional. For example, the same algorithm may work without padding, however padding may be beneficial as being more efficient in training neural network 104.

The embedding matrix may be used to embed each coordinate to vector of size 64 and then we concatenate the embeddings for each coordinate to obtain input vector of size <batch size, sequence length, 512>. Sequence length in this case is equal to 1000 words. The label for the model is the adjacency matrix of shape <sequence length, sequence length> in which 1s indicate that the words should be jointed together into line.

As noted above, neural network 104 may compute both a key matrix 122 and a query matrix 124. In some embodiments, the matrices 122, 124 may be vectors generated by an embedding layer of the neural network. In some embodiments, neural network 104 may then multiply the key matrix 122 and the query matrix 124 to generate an adjacency matrix 126. In some embodiments, the adjacency matrix 126 may include a logits matrix (e.g., which includes pre-sigmoid values) on which a sigmoid function is applied.

In some embodiments, the adjacency matrix 126 may vary in size depending on the number of words identified by the OCR 116. For example, the adjacency matrix 126 may be of a size: number of words x number of words. So, if 20 words were identified, the adjacency matrix 126 may be of size 20×20. As described above, this may be padded to 1000 words in some embodiments, which may help improve efficiency.

In some embodiments, the adjacency matrix 126 may include values between 0 and 1, and may represent which words are connected together (e.g., on the same line). In some embodiments, the value in the adjacency matrix may indicate a confidence score indicating a confidence with which the two words are to be joined together on the same line. The closer the value is to 1, the higher the confidence or likelihood the words belong on the same line.

FIG. 2 illustrates an example adjacency matrix 226, according to some embodiments. Document 206 includes example text 108 that includes various bounding boxes 118 as identified by OCR 116. As illustrated, the corresponding adjacency matrix 226 (which may be an example of adjacency matrix 126) includes 6 vertical lines and 6 horizontal lines, corresponding to the 6 identified bounding boxes 118 or words of document 206.

The first line w1 may correspond to the first word “Hello” the second line w2 may correspond to the second word as indicated by the second bounding box “World!”, the third line w3 may correspond to the third word “This”, and so on. As can be seen in adjacency matrix 226, the intersections of w1 (Hello) and w2 (World) both include 1 values indicating they belong on the same line.

For simplicity, the values of adjacency matrix 226 only includes 0 and 1 values, however in other embodiments, the actual values may be between and inclusive or exclusive of 0 and 1, and may indicate a confidence as to whether the two corresponding words belong cluster or the same line (in this example). The higher the value (e.g., closer to 1), the higher the confidence level that they belong on the same line. The words whose intersections include 1 value, may correspond to words that are grouped into the same line cluster 128 by neural network 104.

Returning to FIG. 1, based on the values of adjacency matrix 126, neural network 104 may group or cluster the words of document 106, corresponding to the various bounding boxes 118, into different line clusters 128. Line clusters 128 may include groupings of one or more words from the identified text 108, that appear on the same line in document 106.

In some embodiments, NCS 102 may generate an output document 107 based on the line clusters 128 (identified from adjacency matrix 126). In some embodiments, when neural network 104 identifies the various line clusters 126, neural network 104 may then adjust the alignment of the words to account for any distortions or skews that may have been included in document 106. The output document 107 may include aligned text 130. Aligned text 130 may include the same words, symbols, punctuation, numbering, etc. to the text 108, but may include physical or visual adjustments based on line clusters 128.

For example, if two or more words are grouped together in the same line cluster 128, then the alignment of those words, any skewing or distortion, may be adjusted in aligned text 130 of output document 107 to appear more perpendicular to each other and/or parallel to words on different line clusters 128. The actual alphanumeric text and symbols of aligned text 130 may be identical to the alphanumeric text and symbols of text 108.

The output document 107 may then be provided to a user interface for display for a user or to another system for storing or further processing, which may include reading the aligned text 130, or inputting it into a database or other storage device.

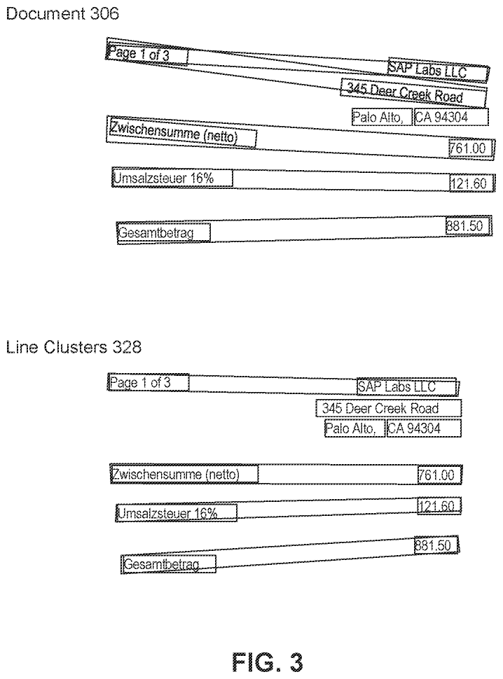

FIG. 3 illustrates example line clusters 328 as may be generated by NCS 102, according to some example embodiments. Document 306 illustrates an example problem with the alignment of words that could occur with general classification or even general clustering systems. Some of the words may include a skew or distortion which may cause words from different lines to be grouped together using horizontal extensions or alignment.

Because there may be some distortion in the image that would cause a system to interpret “Page 1 of 3” and “3475 Deer Creek Road” to be on the same line. However, with the neural network 104, this distinction and distortion can be identified by NCS 102. Line clusters 328 (which is an example of line clusters 128) illustrate a version of document 106 with line clusters 328 shown in the rectangle boxes.

As described above, in some embodiments, NCS 102 may perform a horizontal extension and/or a vertical extension check on the words of line clusters 128. In the horizontal extension check, two words may be horizontally extended, and if the two words intersect, then they may be deemed to occur on the same line (or if they do not intersect, may be considered to be on different lines).

In the vertical extension check, two words may be expanded in the vertical direction and if they intersect with each other, and if they intersect they are not on the same line, if they don't intersect then can merge them together.

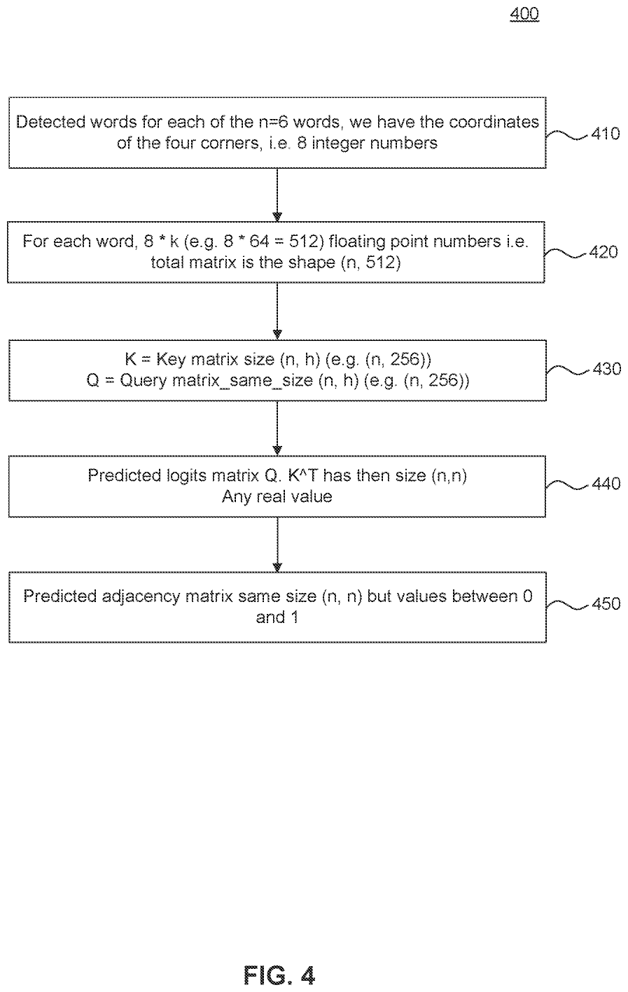

FIG. 4 is a flowchart illustrating a process 400 for a neural clustering system (NCS) 102, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to the figures.

In 410, a document 106 may have been processed by OCR 116, and the coordinates for various bounding boxes 118 may be detected. For example, document 206 of FIG. 2 may include 6 bounding boxes, and neural network 104 may receive the coordinates for the four corners of each bounding box 118.

In 420, for each word, a total matrix is generated. In some embodiments, the total matrix may be of the size and shape of <n, 512>.

In 430, the total matrix for each word may be divided into a key matrix of size <n, 256> and a query matrix of the same size.

In 440, a logits matrix is generated based on multiplying the key matrix and the query matrix. The logits matrix may include any real value in the various entries of the vector or matrix.

In 450, an adjacency matrix is generated. For example, the adjacency matrix 126 may be similar to the logits matrix except that the numbered or real value entries are normalized to be values between 0 and 1. The adjacency matrix 126 may then be used to identify which words belong on the same line or to the same line cluster 128.

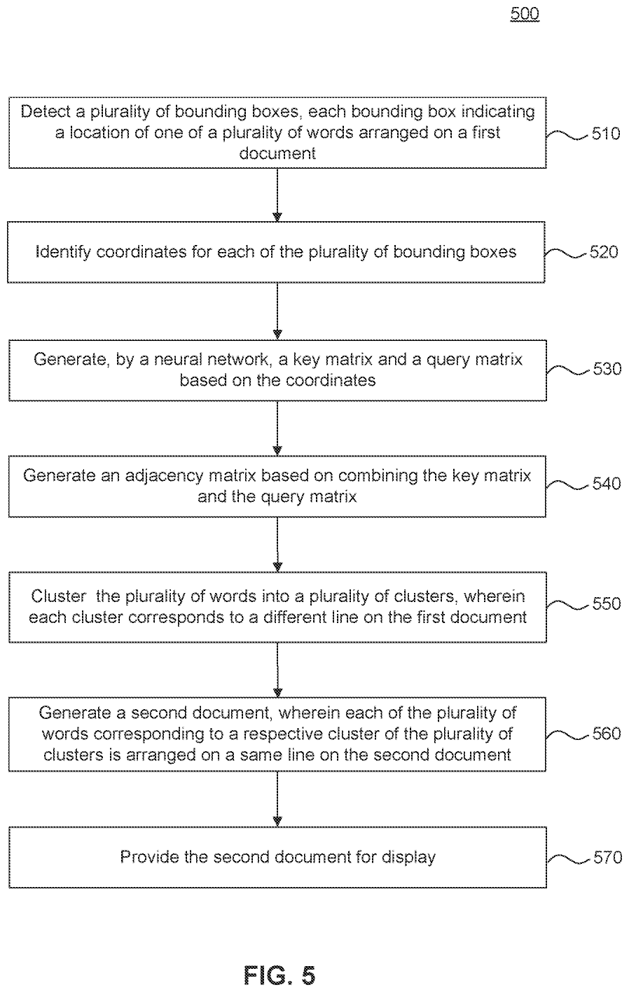

FIG. 5 is a flowchart illustrating another process 500 for a neural clustering system (NCS) 102, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to the figures.

In 510, a plurality of bounding boxes is detected. For example, OCR 116 may generate or provide bounding boxes 118 for the various words detected in document 106. Each bounding box 118 may indicate a location of one of a plurality of words arranged on a first document.

In 520, coordinates for each of the plurality of bounding boxes are identified. For example, NCS 102 may receive coordinates 120 for the various bounding boxes 118. In some embodiments, the coordinates 120 may include four coordinate points, corresponding to each corner of a respective bounding box 118, and together may indicate the size and position of the word (from text 108) in document 106.

In 530, a key matrix and a query matrix is generated based on the coordinates. For example, neural network 104 may generate key matrix 122 and query matrix 124 from coordinates 120.

In 540, an adjacency matrix is generated based on combining the key matrix and the query matrix. For example, NCS 102 may generate an adjacency matrix 126 by multiplying the key matrix 122 and query matrix 124.

In 550, the plurality of words are clustered into a plurality of clusters. For example, NCS 102 may group or cluster the various words (as indicated by bounding boxes 118) into various line clusters 128, based on the values of adjacency matrix 126. Each line cluster 126 may indicate a different line on document 106.

In 560, a second document is generated. For example, neural network 104 may generate output document 107 which may include the words from document 106, belonging to each line cluster 128, with more aligned text 130 (e.g., relative to their alignment in the incoming document 107) to account for any skewing that may have been present in document 106.

In 570, the second document comprising the plurality of words arranged across a plurality of different lines is provided for display. For example, NCS 102 may return the output document 107, including aligned text 130, to a monitor for display or to another system for additional processing.

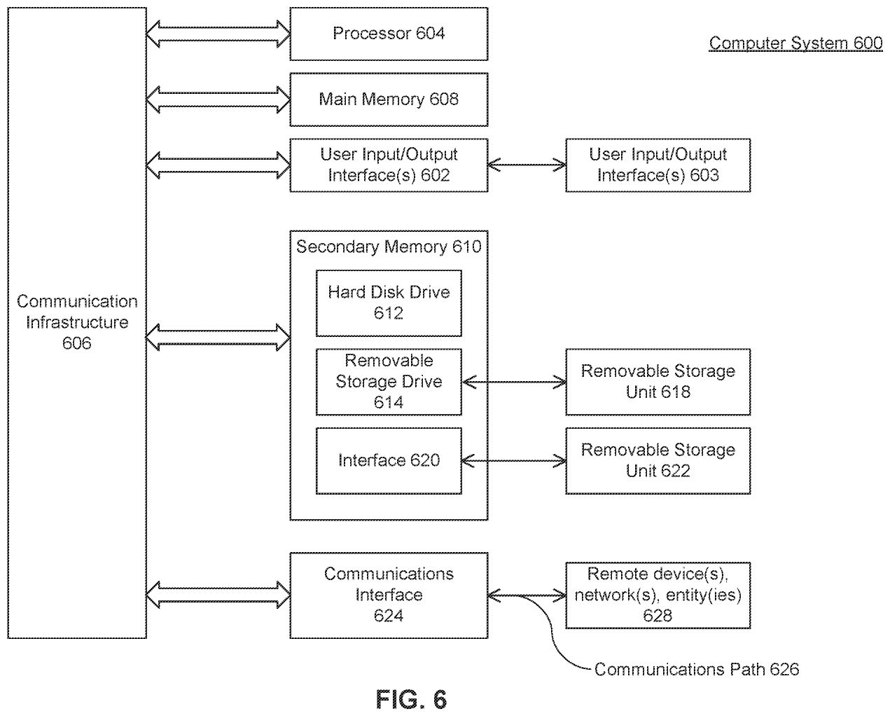

Various embodiments and/or components therein can be implemented, for example, using one or more computer systems, such as computer system 600 shown in FIG. 6. Computer system 600 can be any computer or computing device capable of performing the functions described herein. For example, one or more computer systems 600 can be used to implement any embodiments, and/or any combination or sub-combination thereof.

Computer system 600 includes one or more processors (also called central processing units, or CPUs), such as a processor 604. Processor 604 is connected to a communication infrastructure or bus 606. Computer system 600 may represent or comprise one or more systems on chip (SOC).

One or more processors 604 can each be a graphics processing unit (GPU). In some embodiments, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM) Main memory 608 can include one or more levels of cache. Main memory 608 has stored therein control logic (i.e., computer software) and/or data.

Computer system 600 can also include one or more secondary storage devices or memory 610. Secondary memory 610 can include, for example, a hard disk drive 612 and/or a removable storage device or drive 614. Removable storage drive 614 can be a floppy disk drive, a magnetic tape drive, a compact disk drive, an optical storage device, tape backup device, and/or any other storage device/drive.

Removable storage drive 614 can interact with a removable storage unit 618. Removable storage unit 618 includes a computer usable or readable storage device having stored thereon computer software (control logic) and/or data. Removable storage unit 618 can be a floppy disk, magnetic tape, compact disk, DVD, optical storage disk, memory card, and/any other computer data storage device. Removable storage drive 614 reads from and/or writes to removable storage unit 618 in a well-known manner.

According to an exemplary embodiment, secondary memory 610 can include other means, instrumentalities or other approaches for allowing computer programs and/or other instructions and/or data to be accessed by computer system 600. Such means, instrumentalities or other approaches can include, for example, a removable storage unit 622 and an interface 620. Examples of the removable storage unit 622 and the interface 620 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 can further include a communication or network interface 624. Communication interface 624 enables computer system 600 to communicate and interact with any combination of remote devices, remote networks, remote entities, etc. (individually and collectively referenced by reference number 628). For example, communication interface 624 can allow computer system 600 to communicate with remote devices 628 over communications path 626, which can be wired and/or wireless, and which can include any combination of LANs, WANs, the Internet, etc. Control logic and/or data can be transmitted to and from computer system 600 via communication path 626.

In some embodiments, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections can set forth one or more but not all exemplary embodiments as contemplated by the inventors, and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment.” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
detecting a plurality of bounding boxes, each bounding box indicating a location of one of a plurality of words arranged on a first document;
identifying coordinates for each of the plurality of bounding boxes;
generating, by a neural network, a key matrix and a query matrix based on the coordinates;
generating an adjacency matrix based on combining the key matrix and the query matrix;
clustering the plurality of words into a plurality of clusters, wherein each cluster corresponds to a different line on the first document;
generating a second document, wherein each of the plurality of words corresponding to a respective cluster of the plurality of clusters is arranged on a same line on the second document; and
providing the second document comprising the plurality of words arranged across a plurality of different lines, in accordance with the plurality of clusters, for display.

2. The method of claim 1, wherein the adjacency matrix includes a numerical value for each word.

3. The method of claim 2, wherein the numerical value is between zero and one.

4. The method of claim 1, wherein the generating the adjacency matrix comprises multiplying the key matrix and the query matrix, wherein the adjacency matrix is a product of the multiplying.

5. The method of claim 1, wherein the clustering comprises structured clustering using names for the clusters as provided during a training of the neural network.

6. The method of claim 1, wherein the plurality of different lines on the second document correspond to a plurality of different lines on the first document.

7. The method of claim 1, further comprising:
identifying a first word and a second word, of the plurality of words, belonging to the same line based on the adjacency matrix; and
performing a vertical extension check on the first word with the second word, wherein the vertical extension check comprises determining whether there is a vertical intersection between the first word and the second word indicating that the first word and the second word are on different lines.

8. A system comprising at least one processor, the at least one processor configured to perform operations comprising:
detecting a plurality of bounding boxes, each bounding box indicating a location of one of a plurality of words arranged on a first document;
identifying coordinates for each of the plurality of bounding boxes;
generating, by a neural network, a key matrix and a query matrix based on the coordinates;
generating an adjacency matrix based on combining the key matrix and the query matrix;
clustering the plurality of words into a plurality of clusters, wherein each cluster corresponds to a different line on the first document;
generating a second document, wherein each of the plurality of words corresponding to a respective cluster of the plurality of clusters is arranged on a same line on the second document; and
providing the second document comprising the plurality of words arranged across a plurality of different lines, in accordance with the plurality of clusters, for display.

9. The system of claim 8, wherein the adjacency matrix includes a numerical value for each word.

10. The system of claim 9, wherein the numerical value is between zero and one.

11. The system of claim 8, wherein the generating the adjacency matrix comprises multiplying the key matrix and the query matrix, wherein the adjacency matrix is a product of the multiplying.

12. The system of claim 8, wherein the clustering comprises structured clustering using names for the clusters as provided during a training of the neural network.

13. The system of claim 8, wherein the plurality of different lines on the second document correspond to a plurality of different lines on the first document.

14. The system of claim 8, the operations further comprising:
identifying a first word and a second word, of the plurality of words, belonging to the same line based on the adjacency matrix; and
performing a vertical extension check on the first word with the second word, wherein the vertical extension check comprises determining whether there is a vertical intersection between the first word and the second word indicating that the first word and the second word are on different lines.

15. A non-transitory computer-readable medium having instructions stored thereon that, when executed by at least one computing device, cause the at least one computing device to perform operations comprising:
detecting a plurality of bounding boxes, each bounding box indicating a location of one of a plurality of words arranged on a first document;
identifying coordinates for each of the plurality of bounding boxes;
generating, by a neural network, a key matrix and a query matrix based on the coordinates;
generating an adjacency matrix based on combining the key matrix and the query matrix;
clustering the plurality of words into a plurality of clusters, wherein each cluster corresponds to a different line on the first document;
generating a second document, wherein each of the plurality of words corresponding to a respective cluster of the plurality of clusters is arranged on a same line on the second document; and
providing the second document comprising the plurality of words arranged across a plurality of different lines, in accordance with the plurality of clusters, for display.

16. The non-transitory computer-readable medium of claim 15, wherein the adjacency matrix includes a numerical value for each word.

17. The non-transitory computer-readable medium of claim 16, wherein the numerical value is between zero and one.

18. The non-transitory computer-readable medium of claim 15, wherein the generating the adjacency matrix comprises multiplying the key matrix and the query matrix, wherein the adjacency matrix is a product of the multiplying.

19. The non-transitory computer-readable medium of claim 15, wherein the clustering comprises structured clustering using names for the clusters as provided during a training of the neural network.

20. The non-transitory computer-readable medium of claim 15, wherein the plurality of different lines on the second document correspond to a plurality of different lines on the first document.
